(19) United States
(12) Patent Application Publication
(10) Pub. No.: US 2026/0280453 A1
(43) Pub. Date: Sep. 17, 2026

(54) Transport System and Method for Controlling a Linear-Motor-Based Transport System

(71) Applicant: Siemens Aktiengesellschaft, Muenchen (DE)

(72) Inventors: Martin STREUBÜHR, Zirndorf (DE); Philipp KUNZE, Nürnberg (DE); Christian CRAMER, Burgthann-Ezelsdorf (DE); Bernd WEDEL, Möhrendorf (DE)

(21) Appl. No.: 19/141,407

(22) PCT Filed: Dec. 5, 2023
(86) PCT No.: PCT/EP2023/084230

§ 371 Date: Jun. 20, 2025

(30) Foreign Application Priority Data
Dec. 23, 2022 (EP) 22216342

(51) Int. Cl. H02P 6/00; H02P 21/22; H02P 25/06

(52) U.S. Cl. CPC H02P 6/006; H02P 21/22; H02P 25/06

(57) ABSTRACT

A method for controlling at least one linear motor for a transport system, wherein the transport system includes a transport rotor which, on at least one side, has a plurality of magnets, where at least two magnets have different magnetic polarity, and which has a return element, the control device controls the at least one linear motor such that a longitudinal force is exerted on the transport rotor in a longitudinal direction of the linear motor to effect a linear movement of the transport rotor in the longitudinal direction and controls the at least one linear motor such that a transverse force that is perpendicular to the longitudinal force is exerted on the transport rotor so as to effect a transverse movement of the transport rotor toward the coils or away from the coils, and a field-varying current is zero when the transverse movement of the transport rotor is effected.

### CROSS-REFERENCE TO RELATED APPLICATIONS

This is a U.S. national stage of application No. PCT/EP2023/084230 filed 5 Dec. 2023. Priority is claimed on European Application No. 22216342.0 filed 23 Dec. 2022, the content of which is incorporated herein by reference in its entirety.

### BACKGROUND OF THE INVENTION

### 1. Field of the Invention

The invention relates to a transport system comprising at least one linear motor which has a plurality of coils, a controller which configured to control the at least one linear motor, a transport rotor which, on at least one side, has a plurality of magnets, where at least two magnets have different magnetic polarities, and which has a return element, in particular a back iron element, where the controller is configured to control the at least one linear motor such that a longitudinal force is exerted on the transport rotor in a longitudinal direction of the linear motor in order to effect a linear movement of the transport rotor in the longitudinal direction.

The invention also relates to a method for controlling at least one linear motor for a transport system, where the at least one linear motor has a plurality of coils, where the transport system has a transport rotor which, on at least one side, has a plurality of magnets, where at least two magnets have different magnetic polarities, and which has a return element, in particular a back iron element, and where the control device controls the at least one linear motor such that a longitudinal force is exerted on the transport rotor in a longitudinal direction of the linear motor in order to effect a linear movement of the transport rotor in the longitudinal direction.

### 2. Description of the Related Art

Modern production machines require flexible machine layouts in which material flows can be separated and merged. For maximum productivity, high process speeds are additionally necessary.

In AT 517219 B1, workpiece carriers are disclosed that travel through a switch point in three steps. Two linear motors are oppositely disposed at a short distance ahead of the switch point and at an increasing distance after the switch point. The forces of attraction F1 and F2 acting on the workpiece carrier are intensified by a field-varying Ip current and oppositely attenuated such that the workpiece carrier on the linear motor section located on the left in the direction of travel continues moving forward. When activated in the inverse sense, the workpiece carrier on the linear motor section located on the right in the direction of travel continues moving forward.

In AT 520088 B1 and EP 3661033 A1, additional devices and actuators are provided, as a result of which the costs for such a transport system are relatively high.

In DE 10 2019 117 351 A1, the magnetic attraction forces are overridden by an additional motor-driven actuator, likewise resulting in additional costs.

### SUMMARY OF THE INVENTION

It is an object of the present invention to provide a transport system or, as the case may be, a method for controlling a linear motor for a transport system that enables a switch functionality to be realized with the lowest possible overhead in terms of energy and material.

This and other objects and advantages are achieved in accordance with the invention by a transport system in which a control device is configured to control at least one linear motor such that a transverse force that is perpendicular to the longitudinal force is exerted on the transport rotor such that a transverse movement of the transport rotor toward the coils or away from the coils is effected, where a field-varying current has a value of zero while the transverse movement of the transport rotor is being effected.

The control device may be for example a SIMATIC S7 controller from the company SIEMENS. The transverse movement of the transport rotor can preferably be used for implementing a switch functionality. Here, the transport rotor is diverted from a first direction to a different direction in order, for example, to travel on an alternative route to a main line.

The transport system in accordance with the invention is particularly advantageously configured to exert a transverse force on the transport rotor without the need in the process for a field-varying current to effect the transverse force. In contrast to conventional transport systems, in particular in contrast to the system known from AT 517219 B1, it is not necessary to impress a field-varying current to effect the transverse movement of the transport rotor. As a result, control of the linear motor is simplified and can be accomplished in a more energy-efficient manner. Additional actuators or comparable devices, as sometimes required in the prior art, are not necessary in the transport system according to the invention.

Particularly preferably, the control device of the transport system is configured to control the at least one linear motor such that the transverse movement of the transport rotor toward the coils or away from the coils is effected via an acceleration of the transport rotor in the longitudinal direction of the linear motor. This can be achieved by the control device via a suitable energization of the linear motor. Different degrees of acceleration can be chosen depending on the required diversion of the transport rotor. For more specific details on this, reference is made to the description of the exemplary embodiments.

Quite particularly preferably, the control device is configured to accomplish the acceleration of the transport rotor as a high-frequency modulation with alternating signs, a frequency of the modulation preferably amounting to more than 100 hertz. Here, the high-frequency modulation of the acceleration of the transport rotor can be effected by a correspondingly high-frequency modulation of a coil current of the linear motor. The alternating acceleration causes the transport rotor to be alternately pulled forward and back in the direction of travel. In addition, the current flow through the coils of the linear motor produces an attraction force on the return element of the transport rotor (reluctance force)—moreover irrespective of whether the transport rotor is accelerated positively or negatively. The forces in the direction of travel lie around zero on average due to the alternating acceleration, i.e., there is no unwanted braking or (positive) acceleration of the transport rotor.

Within the scope of a preferred embodiment of the invention, the linear motor of the transport system has no return element, i.e., no back iron element. This can mean that no back iron, no return sheet, no return plate, no iron teeth or the like are constructed in a stator of the linear motor, i.e., air core coils are used. As a result, no permanent magnetic attraction force on the linear motor is generated by the permanent magnets of the transport rotor. Owing to the absence of the permanent magnetic attraction forces, lower transverse forces need to be generated in order to effect a change in direction of the transport rotor for implementing the switch functionality. As a result, the transport system can be operated in a more energy-efficient manner. In AT 517219 B1, the forces of the permanent magnets of the transport rotor must be equalized via the field current feedback control system. The opposite forces have a nonlinear force curve and therefore require a very precise mechanical alignment of the switch parts. The embodiment of the invention without return in the linear motor eliminates the interfering permanent forces and permits greater mechanical tolerances in a switch realized via the transport system.

Particularly preferably, the transport system comprises at least one first linear motor and a second linear motor arranged at a distance substantially parallel to the first linear motor. Here, the transport rotor comprises a plurality of magnets on a further side, where at least two magnets are of different magnetic polarity, and where the return element is arranged between the sides containing the magnets. The control device is, in this case, configured to control the first linear motor and the second linear motor such that a longitudinal force is exerted on the transport rotor arranged between the first and the second linear motor in a common longitudinal direction of the first and the second linear motor in order to effect a linear movement of the transport rotor in the longitudinal direction, and where the control device is further configured to control the first and/or the second linear motor such that a transverse force that is perpendicular to the longitudinal force is exerted on the transport rotor such that a transverse movement of the transport rotor is effected toward the coils of the first linear motor or toward the coils of the second linear motor, and where a field-varying current has a value of zero while the transverse movement of the transport rotor is being effected.

An attraction force pulling the transport rotor in the direction of the first linear motor can, in this case, effect a movement of the transport rotor along a first direction track, while an attraction pulling in the direction of the second linear motor can effect a movement of the transport rotor along a second direction track. This enables a switch functionality to be realized in a particularly simple manner.

Particularly preferably, both the first and the second linear motor have no return elements, in particular no back iron. The advantages associated therewith have already been explained in the foregoing.

The objects and advantages are also achieved in accordance with the invention by a method for controlling at least one linear motor for a transport system, where the at least one linear motor has a plurality of coils, and where the transport system comprises a transport rotor which, on at least one side, has a plurality of magnets, where at least two magnets are of different magnetic polarity, and which has a return element, in particular a back iron element, where the controller controls the at least one linear motor such that a longitudinal force is exerted on the transport rotor in a longitudinal direction of the linear motor to effect a linear movement of the transport rotor in the longitudinal direction. The method is characterized in that the controller controls the at least one linear motor such that a transverse force that is perpendicular to the longitudinal force is exerted on the transport rotor such that a transverse movement of the transport rotor is effected toward the coils or away from the coils, where a field-varying current has a value of zero while the transverse movement of the transport rotor is being effected.

The controller preferably controls the at least one linear motor such that the transverse movement of the transport rotor toward the coils or away from the coils is effected via an acceleration of the transport rotor in the longitudinal direction of the linear motor.

The controller can form the acceleration of the transport rotor as a high-frequency modulation with alternating signs, where a frequency of the modulation preferably amounts to more than 100 hertz. Here, the controller can effect the high-frequency modulation of the acceleration of the transport rotor via a correspondingly high-frequency modulation of a coil current of the linear motor.

As already mentioned previously, in this case the linear motor preferably has no return element, in particular no back iron element.

Within the scope of a preferred embodiment of the method, the transport system has at least one first linear motor and a second linear motor arranged at a distance substantially parallel to the first linear motor, where the transport rotor has a plurality of magnets on a further side, where at least two magnets have different magnetic polarities, and where the return element is arranged between the two sides containing the magnets, where the controller controls the first and second linear motors such that a longitudinal force is exerted on the transport rotor arranged between the first and second linear motors in a common longitudinal direction of the first and second linear motors to effect a linear movement of the transport rotor in the longitudinal direction, and where the controller controls the first and/or the second linear motor such that a transverse force that is perpendicular to the longitudinal force is exerted on the transport rotor such that a transverse movement of the transport rotor is effected toward the coils of the first linear motor or toward the coils of the second linear motor, and where a field-varying current has a value of zero while the transverse movement of the transport rotor is being effected.

The objects and advantages are also achieved in accordance with the invention by a computer program stored in memory which, when executed on a controller, causes the controller to perform a method in accordance with disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described characteristics, features and advantages of this invention, as well as the manner in which these are achieved, will become clearer and more readily understandable in connection with the following description of the exemplary embodiments, which are explained in more detail in conjunction with the figures, in which:

FIG. 1 shows a linear-motor-based transport system in accordance with a first embodiment;

FIG. 2 shows a linear-motor-based transport system in accordance with a second embodiment;

FIG. 3 shows a linear-motor-based transport system in accordance with a third embodiment;

FIG. 4 shows a linear-motor-based transport system in accordance with a fourth embodiment;

FIG. 5 shows a linear-motor-based transport system in accordance with a fifth embodiment; and

FIG. 6 is a flowchart of the method in accordance with the invention.

### DETAILED DESCRIPTION OF THE EXEMPLARY EMBODIMENTS

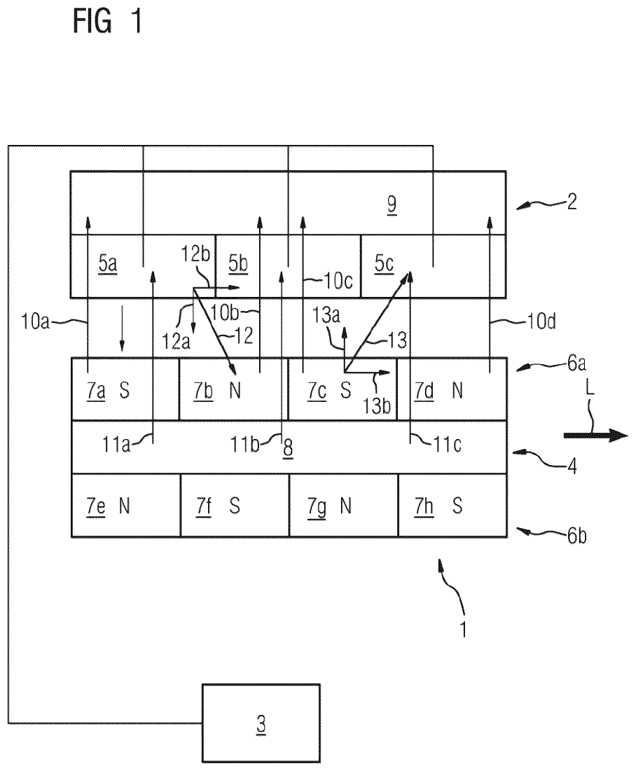

FIG. 1 shows a transport system 1 that comprises a linear motor 2, a control device 3 and a transport rotor 4. The linear motor 2 has a plurality of electromagnetic coils 5a, 5b, 5c and a back iron element 9.

On a first side 6a that is disposed opposite the linear motor 2, the transport rotor 4 has a plurality of magnets 7a, 7b, 7c, 7d. The magnets 7a, 7b, 7c, 7d are of different polarity (S denotes a magnetic south pole, N a magnetic north pole). On a second side 6b, the transport rotor 4 likewise has a plurality of magnets 7e, 7f, 7g, 7h, each having a different polarity. Between the two sides 6a, 6b containing the magnets 7a, 7b, 7c, 7d, 7e, 7f, 7g, 7h, the transport rotor 4 has a back iron element 8. In this exemplary embodiment, the magnets 7a, 7b, 7c, 7d, 7e, 7f, 7g, 7h are formed as permanent magnets. However, they may also be formed as electromagnets that effect a magnetic attraction force only when a current flows through the electromagnets.

The controller 3 is connected to the coils 5a, 5b, 5c of the linear motor 2 and feeds a current into the coils 5a, 5b, 5c. Here, each coil 5a, 5b, 5c can be supplied with current separately and independently of the other coils 5a, 5b, 5c.

The magnetic forces acting in the transport system 1 are explained in the following: The magnets 7a, 7b, 7c, 7d on the first side 6a exert a permanent magnetic attraction force 10a, 10b, 10c, 10d on the back iron element 9 of the linear motor 2 and pull the transport rotor 4 in the direction of the linear motor 2. The attraction forces acting on the back iron element 9 via the magnets 7e, 7f, 7g, 7h are negligible.

An appropriate current flow through the coils 5a, 5b, 5c of the linear motor 2 causes a magnetic field to be induced that exerts a magnetic attraction force 11a, 11b, 11c on the back iron element 8 of the transport rotor 4 and pulls the transport rotor in a transverse direction in the direction of the linear motor 2. At the same time, depending on the embodiment of the coil 5a, 5b, 5c or depending on the direction of the current flow through the coils 5a, 5b, 5c, the magnetic fields induced via the coils 5a, 5b, 5c interact with the magnets 7a, 7b, 7c, 7d on the first side 6a of the transport rotor 4 (the second side 6b is once again negligible).

In the exemplary embodiment illustrated in FIG. 1, at a specific point in time, a repelling magnetic force 12 is exerted from the left between the coil 5a on the left in the drawing and the second magnet 7b formed as a magnetic north pole. The force 12 comprises a transverse component 12a and a longitudinal component 12b. The transverse component 12a repels the transport rotor 4 away from the linear motor 2, and the longitudinal component 12b effects a linear movement of the transport rotor 4 in a longitudinal direction L.

At this point in time, the second coil 5b is currentless and therefore effects no magnetic forces between linear motor 2 and transport rotor 4.

At the specific point in time, a repelling magnetic force 13 is exerted from the left between the coil 5c on the right in the drawing and the third magnet 7c formed as a magnetic south pole. The force 13 comprises a transverse component 13a and a longitudinal component 13b. The transverse component 13a pulls the transport rotor 4 toward the linear motor 2, while the longitudinal component 12b effects a linear movement of the transport rotor 4 in a longitudinal direction L.

The control device 3 can supply the coils 5a, 5c with current at the specific point in time such that the transport rotor 4 is held at a constant distance from the linear motor 2 and at the same time is moved forward in the longitudinal direction L. If, however, a transverse movement of the transport rotor 4 is wanted, so as to realize a switch functionality, for example, the control device 3 can adjust the ratio between the magnetic force 12 of the first coil 5a and the magnetic force 13 of the third coil 5c such that the transverse force 13a attracting the transport rotor 4 (in conjunction with the static forces 10a, 10b, 10c, 10d, 11a, 11c) is greater than the transverse force 12a repelling the transport rotor 4. in this way, the transport rotor 4 experiences in total an attraction in the direction of the linear motor 2, as a result of which the transport rotor 4 performs a transverse movement.

It is important that the transverse movement of the transport rotor 4 is not effected by a reduction in repelling forces between the first coil 5a and the first magnet 7a, or between the third coil 5c and the fourth magnet 7d. In other words, a field-varying current (in the case of linear motors also designated as I_{D}) through the coils 5a, 5b, 5c while the transverse movement of the transport rotor 4 is being effected has a value of zero. In contrast to the attenuation of the attraction of the transport rotor 4 known from AT 0517219 B1, for example, via a repulsion of the transport rotor 4 induced due to a field-weakening current, the transverse movement of the transport rotor 4 is effected via an adjustment of the (longitudinal) acceleration of the transport rotor 4. In this context, reference is made to an Io current, which effects the longitudinal movement of the transport rotor 4.

Only three coils 5a, 5b, 5c are shown in FIG. 1. However, it should be understood that the linear motor 2 may comprise numerous further coils 5a, 5b, 5c in order to enable a longer transport section to be realized.

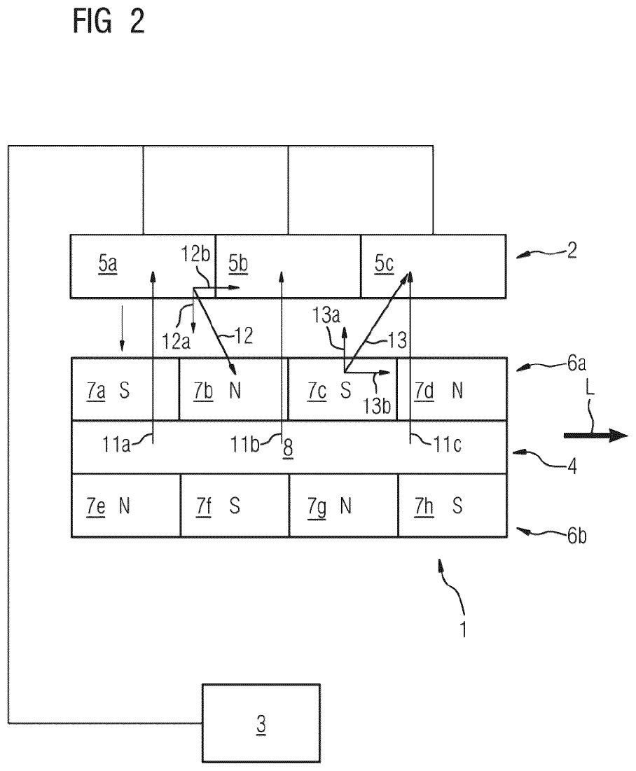

The linear motor 2 can be implemented without a back iron element 9, as is shown in FIG. 2. In other words, the linear motor 2 in this example comprises only air core coils 5a, 5b, 5c. The linear motor 2 is therefore constructed without iron teeth and without a return plate and in particular has no back iron, no return sheet and also no other return element. As a result, the (constant) attraction forces 10a, 10b, 10c, 10d between the magnets 7a, 7b, 7c, 7d of the transport rotor 4 and the linear motor 2 are absent. Consequently, relatively small transverse forces 12a, 13a must be generated via the coils 5a, 5c (via the I_{Q} current) in order, for example, to perform a route switchover.

It is advantageous if the return element 9 of the linear motor 2 is dispensed with, specifically in a switch region of the transport system 1, because the linear motor 2 possesses a lower efficiency without the return element 9. A general dispensing with the return element 9 is therefore not advantageous.

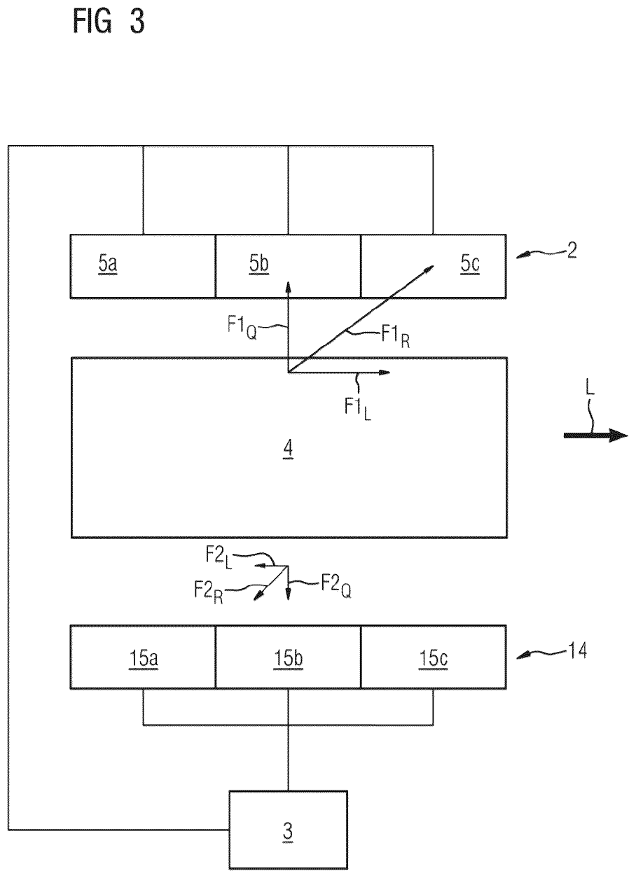

FIG. 3 shows a further possible embodiment of a transport system 1 in accordance with the invention. In addition to the (first) linear motor 2, the transport system 1 comprises a second linear motor 14 that can be realized as identical in construction to the first linear motor 2. The second linear motor 14 has (at least) three electromagnetic coils 15a, 15b, 15c. Both linear motors 2, 14 have no return element in the illustrated region (cf. FIG. 2). The transport rotor 4 is represented in simplified form (without showing individual magnets, though these are present analogously to FIG. 1 and FIG. 2) and is moved in a longitudinal direction L between the two linear motors 2, 14. As described previously with reference to FIG. 1 and FIG. 2, when the coils 5a, 5b, 5c, 15a, 15b, 15c are energized by a suitable current, both linear motors 2, 14 generate a magnetic force FIR, F2R, which comprise a longitudinal component F1_{L}, F2_{L} and a transverse component F1_{Q}, F2_{Q}.

In the present example, the transport rotor 4 is guided closer to the first linear motor 2 than to the second linear motor 14. This is realized via a correspondingly larger transverse component F1_{Q} effected by the first linear motor 2. A field-weakening current I_{D} is also zero, in this case. The transverse component F2_{Q} effected by the second linear motor 14 is negative in this case, and hence not zero, in order to enable a soft transition of the transport rotor from a track extending closer to the second linear motor 14 in the direction of the first linear motor 2 (e.g., at a switch). However, the transverse component F2_{Q} may also be greater than zero, being required only to be less than the first transverse component F1_{Q} in order in total to effect an attraction toward the first linear motor 2.

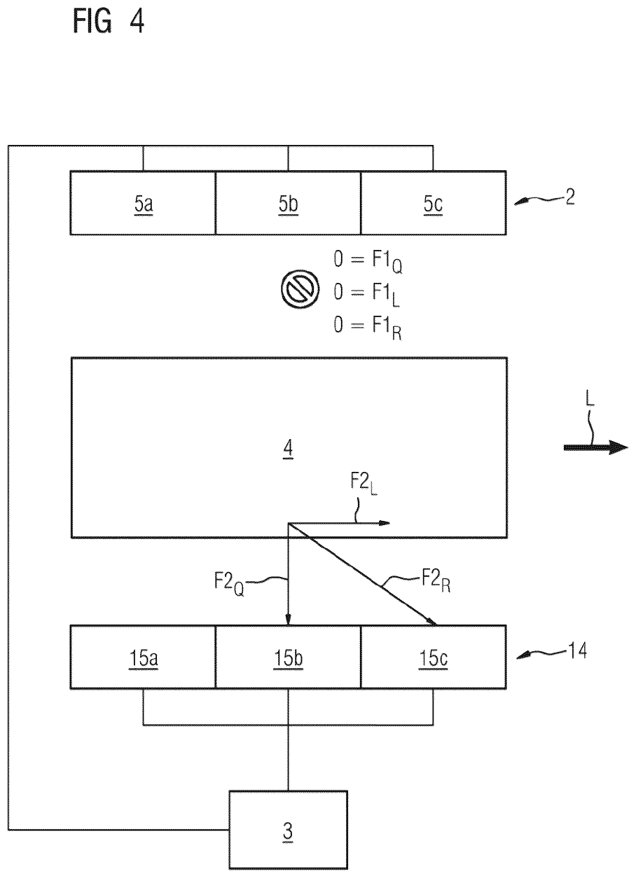

A further possible embodiment of the invention is shown in FIG. 4. Here, the first linear motor 2 effects no magnetic attraction that is induced by the coils 5a, 5b, 5c (coil current is zero). Analogously to FIG. 3, the second linear motor 14 produces a force component F2_{Q} in the direction of the second linear motor 14 to guide the transport rotor 4 closer to the second linear motor 14. The force component F2_{Q} (as also the force components F2_{L} and F2_{R}) is in this case produced by the coils 15a, 15b, 15c of the second linear motor 14 both in an acceleration operation (I_{Q}>0) and in a braking operation (I_{Q}<0).

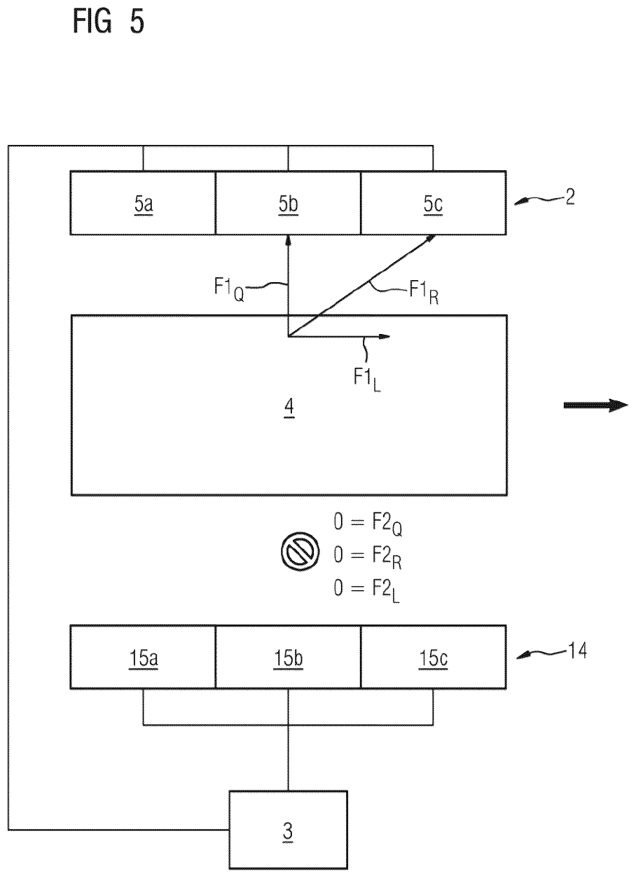

In FIG. 5, the reverse case to that illustrated in FIG. 4 is shown. Here, the second linear motor 14 produces no magnetic attraction that is induced by the coils 15a, 15b, 15c (coil current is zero). Analogously to FIG. 3, the first linear motor 2 produces a force component Flo in the direction of the first linear motor 2 in order to guide the transport rotor 4 closer to the first linear motor 2. The force component F1_{Q} (as also the force components F1_{L} and F1_{R}) is in this case produced by the coils 5a, 5b, 5c of the first linear motor 2 both in an acceleration operation (I_{Q}>0) and in a braking operation (I_{Q}<0).

In order to realize a transverse movement of the transport rotor 4 without a field-varying current I_{D}, which constitutes the idea at the core of the present invention, a current controller and a speed controller can be part of the control device 3 for each linear motor 2, 14 of FIG. 3 and FIG. 5 (in the case of just one linear motor 2, analogously only for the one motor). From the speed control operation there results an I_{Q} current corresponding to the speed setpoint specification. At a constant speed, for example, this I_{Q} current is virtually constant and relatively small since no acceleration forces are acting. The specified attraction force is converted into an auxiliary Io current. The auxiliary I_{Q} current is modulated at a high frequency (e.g. >100 Hz) and superimposed. Both current setpoint values are supplied to the current controller.

The auxiliary I_{Q} current is always a value greater than or equal to zero and corresponds to the amplitude of the high-frequency signal. The modulated auxiliary I_{Q} current pulls the transport rotor 4 alternately forward and back. At the same time, an attraction force is produced between the coils 5a, 5b, 5c, 15a, 15b, 15c and the magnets 7a, 7b, 7c, 7d, 7e, 7f in the transport rotor 4. On average, the alternating forward and backward movements cancel one another out and the attraction forces are retained. Accordingly, no change of speed results on average from the drive function.

The effective attraction force depends on frequency and amplitude and must be modulated by the drive function in accordance with the attraction force setpoint value in at least the amplitude and, if applicable, also the frequency. The magnets 7a, 7b, 7c, 7d, 7e, 7f can be mounted in a damped arrangement and/or the frequency changed to fit the mechanical configuration.

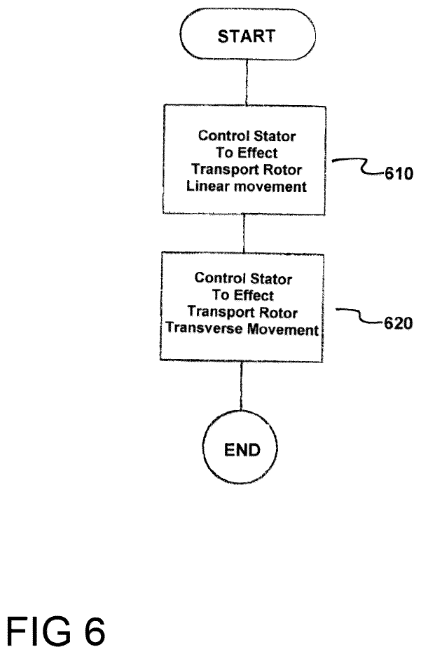

FIG. 6 is a flowchart of the method for controlling at least one linear motor 2, 14 for a transport system 1, where the at least one linear motor 2, 14 includes a stator 2, 14 having a plurality of coils 5a, 5b, 5c, 15a, 15b, 15c, and where the linear motor includes a transport rotor 4 having a plurality of magnets 7a, 7b, 7c, 7d on at least one side 6a and includes a return element 8, where at least two magnets 7a, 7b, 7c, 7d are of different magnetic polarities.

The method comprises controlling, by the controller 3, the at least one stator 2, 14 such that a longitudinal force 12b, 13b, F1L, F2L is exerted on the transport rotor 4 in a longitudinal direction of the linear motor 2, 14 to effect a linear movement L of the transport rotor 4 in the longitudinal direction, indicated in step 610.

Next, controller 3 controls the at least one stator 2, 14 such that a transverse force 12a, 13a, F1Q, F2Q which is perpendicular to the longitudinal force 12b, 13b, F1L, F2L is exerted on the transport rotor 4 to realize a switch functionality such that a transverse movement of the transport rotor 4 toward the plurality of coils 5a, 5b, 5c, 15a, 15b, 15c or away from the plurality of coils 5a, 5b, 5c, 15a, 15b, 15c is effected, as indicated in step 620. In accordance with the method of the invention, a field-varying current ID has a value of zero while the transverse movement of the transport rotor 4 is being effected.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A transport system comprising:
at least one linear motor including at least one stator having a plurality of coils;
a controller which is configured to control the at least one stator;
a transport rotor of the linear motor which, on at least one side, includes a plurality of magnets and a return element, at least two magnets having different magnetic polarities;
wherein the controller is configured to control the stator such that a longitudinal force is exerted on the transport rotor in a longitudinal direction of the at least one linear motor to effect a linear movement of the transport rotor in the longitudinal direction;
wherein the controller is further configured to control the at least one stator such that a transverse force which is perpendicular to the longitudinal force is exerted on the transport rotor such that a transverse movement of the transport rotor toward the plurality of coils or away from the plurality of coils is effected to realize a switch functionality; and
wherein a field-varying current has a value of zero while the transverse movement of the transport rotor is being effected.

16. The transport system as claimed in claim 15, wherein the controller is further configured to control the at least one stator such that the transverse movement of the transport rotor toward the plurality of coils or away from the plurality of coils is effected via an acceleration of the transport rotor in the longitudinal direction of the linear motor.

17. The transport system as claimed in claim 16 wherein the controller is further configured to form the acceleration of the transport rotor as a modulation with alternating signs; and wherein a frequency of the modulation amounts to more than 100 hertz.

18. The transport system as claimed in claim 17, wherein the controller is further configured to effect the modulation of the acceleration of the transport rotor via a corresponding modulation of a coil current of the at least one stator.

19. The transport system as claimed in claim 15, wherein the at least one stator has no return element.

20. The transport system as claimed in claim 15, wherein the return element comprises a back iron element.

21. The transport system as claimed in claim 15, further comprising:
a first stator; and
a second stator arranged at a distance substantially parallel to the first stator;
wherein the transport rotor has a plurality of magnets on a further side;
wherein at least two magnets have different magnetic polarities;
wherein the return element is arranged between two sides containing the magnets;
wherein the controller is further configured to control the first stator and the second stator such that a longitudinal force is exerted on the transport rotor arranged between the first stator and the second stator in a common longitudinal direction of the first stator and the second stator to effect a linear movement of the transport rotor in the longitudinal direction;
wherein the controller is further configured to control at least one of the first stator and the second stator such that a transverse force which is perpendicular to the longitudinal force is exerted on the transport rotor such that a transverse movement of the transport rotor toward the coils of the first stator or toward the coils of the second stator is effected; and
wherein a field-varying current has a value of zero while the transverse movement of the transport rotor is being effected.

22. The transport system as claimed in claim 21, wherein the first stator and the second stator have no return elements.

23. The transport system as claimed in claim 22, wherein the return elements comprises back iron elements.

24. The transport system as claimed in claim 15, wherein the return element comprises a back iron element.

25. A method for controlling at least one linear motor for a transport system, the at least one linear motor including a stator having a plurality of coils, the linear motor including a transport rotor having a plurality of magnets on at least one side and a return element, and at least two magnets having different magnetic polarities, the method comprising:
controlling, by the controller, the at least one stator such that a longitudinal force is exerted on the transport rotor in a longitudinal direction of the linear motor to effect a linear movement of the transport rotor in the longitudinal direction; and
controlling, by the controller, the at least one stator such that a transverse force which is perpendicular to the longitudinal force is exerted on the transport rotor to realize a switch functionality such that a transverse movement of the transport rotor toward the plurality of coils or away from the plurality of coils is effected;
wherein a field-varying current has a value of zero while the transverse movement of the transport rotor is being effected.

26. The method as claimed in claim 25, wherein the controller controls the at least one stator such that the transverse movement of the transport rotor toward the plurality of coils or away from the plurality of coils is effected via an acceleration of the transport rotor in the longitudinal direction of the linear motor.

27. The method as claimed in claim 26, wherein the controller forms the acceleration of the transport rotor as a modulation with alternating signs; and wherein a frequency of the modulation amounts to more than 100 hertz.

28. The method as claimed in claim 27, wherein the controller effects the modulation of the acceleration of the transport rotor via a corresponding modulation of a coil current of the at least one stator.

29. The method as claimed in claim 25, wherein the at least one stator has no return element.

30. The method as claimed in claim 29, wherein the return element comprises a back iron element.

31. The method as claimed in claim 25, wherein the transport system includes at least one first stator and a second stator arranged at a distance substantially parallel to the first stator;
wherein the transport rotor includes a plurality of magnets on a further side;
wherein at least two magnets have different magnetic polarities;
wherein the return element is arranged between two sides containing the plurality of magnets;
wherein the controller is further configured to control the first stator and the second stator such that a longitudinal force is exerted on the transport rotor arranged between the at least one first stator and the second stator in a common longitudinal direction of the at least one first stator and the second stator to effect a linear movement of the transport rotor in the longitudinal direction; and
wherein the controller is further configured to control at least one of the at least one first stator and the second stator such that a transverse force which is perpendicular to the longitudinal force is exerted on the transport rotor such that a transverse movement of the transport rotor is effected toward the plurality of coils of the at least one first stator or toward the plurality of coils of the second stator to realize a switch functionality; and
wherein a field-varying current has a value of zero while the transverse movement of the transport rotor is being effected.

32. The method as claimed in claim 25, wherein the return element comprises a back iron element.

33. A computer program stored in memory which, when executed by a controller, causes the controller to perform the method as claimed in one of claim 25.
